(19) United States
(12) Patent Application Publication
(10) Pub. No.: US 2011/0197418 A1
(43) Pub. Date: Aug. 18, 2011

(54) String Solar Panel Mounting System

(76) Inventors: Michael Charles Overturf, Washington, DC (US); William D. Taylor, New Milford, CT (US); Wojciech Marek Chrosny, Orange, CT (US)

(21) Appl. No.: 13/021,770

(22) Filed: Feb. 6, 2011

Related U.S. Application Data
(60) Provisional application No. 61/305,051, filed on Feb. 16, 2010.

(51) Int. Cl. B23P 19/04

(52) U.S. Cl. 29/428

(57) ABSTRACT

Mounting system of solar panels (both photovoltaic and solar water heating) using cables and anchored to the sides of the building or to ground mounts is described. The mounting method does not require roof penetrations, minimizing potential for water leaks associated with roof penetrations. The mounting system allows for the panels to be mounted at different heights over the surface of the roof.

This application refers to provisional application No. 61/305051 with the same title and inventors.

### BACKGROUND OF THE INVENTION

Roof-mounted photovoltaic panels must be fastened to resist wind and other environmental influences. Two primary techniques of mounting, (1) anchoring, and (2) ballasting, suffer significant drawbacks to roof owners.
(1) Anchoring is the most permanent, but requires penetration of the impermeable roof surface, increasing the risk of leaks and incurring additional maintenance costs.
(2) Ballasting avoids penetration, but incurs weight penalties that decrease the margin of structural weight tolerance.

Both methods make portions of the roof inaccessible for routine maintenance, therefore decreasing the amount of roof space that can be used for electricity generation.

A tensile suspension avoids contact with impermeable roof membranes, and permits the elevation of solar panel suspension, affording access to the roof while shading the building structure and producing solar electrical power.

### SUMMARY OF THE INVENTION

The present invention provides for variable height suspension mount of solar panels on a flat commercial building roof. The invention offers the maximized use of the roof space for solar power generation while providing unfettered maintenance and construction access to the roof if so desired.

High tensile stainless steel wires are suspended along the structural alignment of a buildings roof structure. The wires are mounted to an elevated support mechanism (tension towers) at either end of the building, which users a cantilevered design to transfer the tensile force to the ground foundation and mounting mechanism.

Variable length C-channel extrusion pairs are clamped orthogonally, or at appropriate north-south azimuth orientation, to the suspended steel wires, oriented along the necessary north-south axis. Solar panels are fastened conventionally against these C-channel pairs. Wires may be suspended at different elevation angles, providing a tilt orientation for the panels.

Tensioning mechanisms along the base of the wires allow for very high tensions, minimizing wind-induced harmonic vibration or excessive structural stress/torque on the panels. Thermal movement of the wires is accommodated through fixed pulleys along the force points of the suspension towers.

The invention allows the use of roof surfaces for solar panel suspension without actual roof contact.

### OBJECT OF THE INVENTION

An object of the invention is to suspend solar panels over a flat roof space without requiring penetrating mounts.

A second object of the invention is to provide solar panel coverage of a flat roof space without requiring ballasted mounting.

A third object of the invention is to suspend the solar panels without requiring removal of or continuing to provide installation or re-arrangement of common roof fixtures such as air handlers, compressors, and vents.

A fourth object of the invention is to suspend solar panels over any large surface area without requiring ground contact in that surface area.

A further object is to provide solar panel suspension of the entire insolation area, affording shaded coverage of the covered area that reduces the temperature and elements exposure, which still meeting the objects described above.

### BRIEF DESCRIPTION OF THE DRAWINGS

FIG. 1 is concept drawing with several mounting strings positioned over a building.

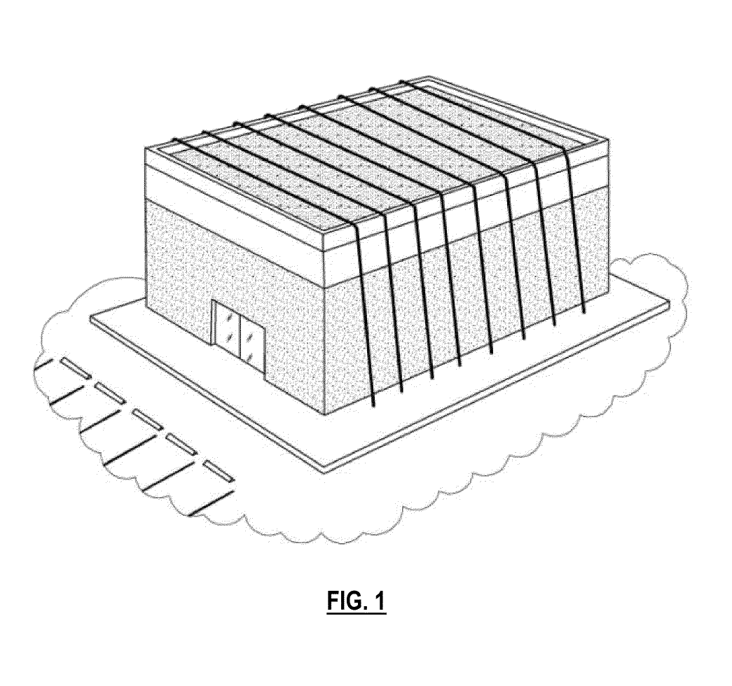

FIG. 2 is the concept drawing showing the roof top view of strings and solar panel mounting details.

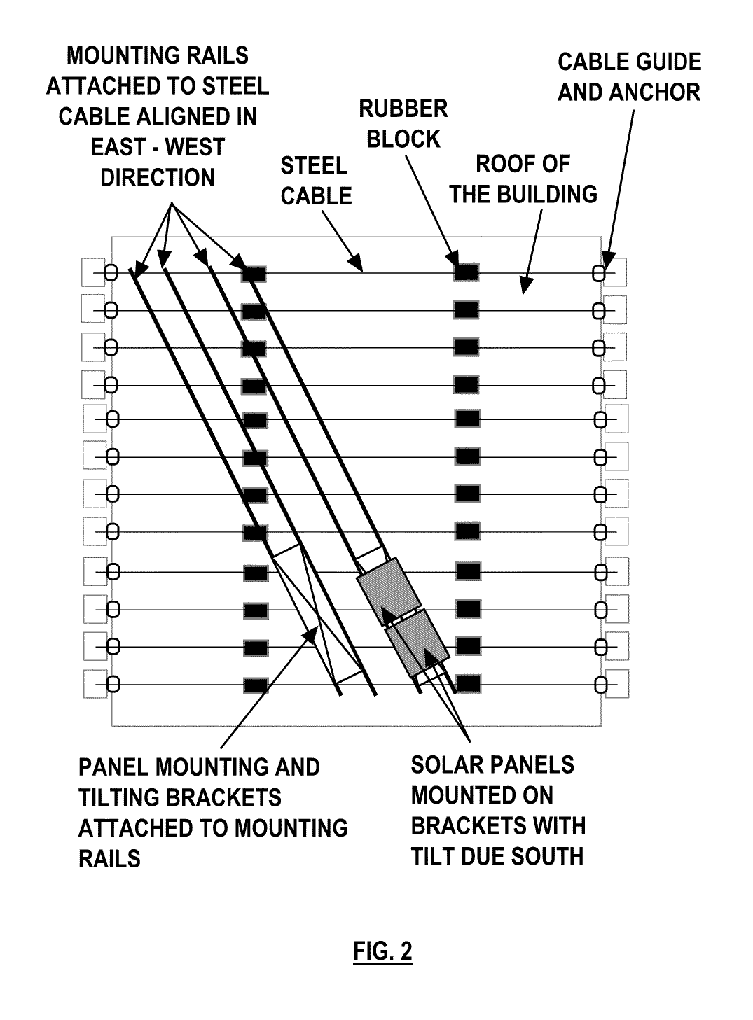

FIG. 3 is the concept drawing showing the string anchoring and corner bracing details.

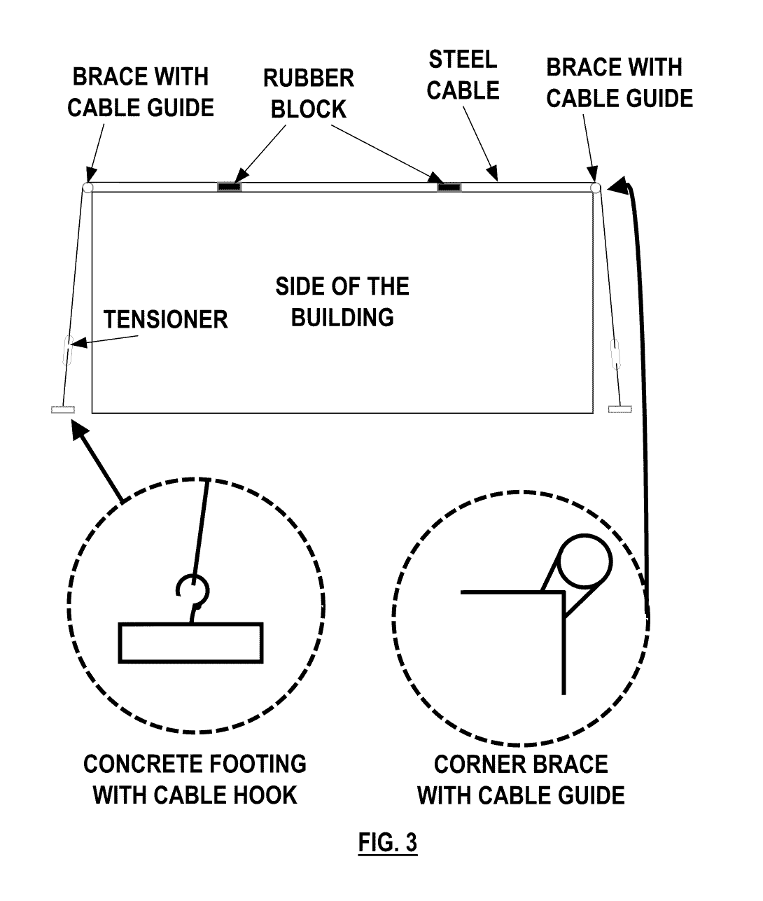

FIG. 4 is the concept drawing showing string mounting using tension towers.

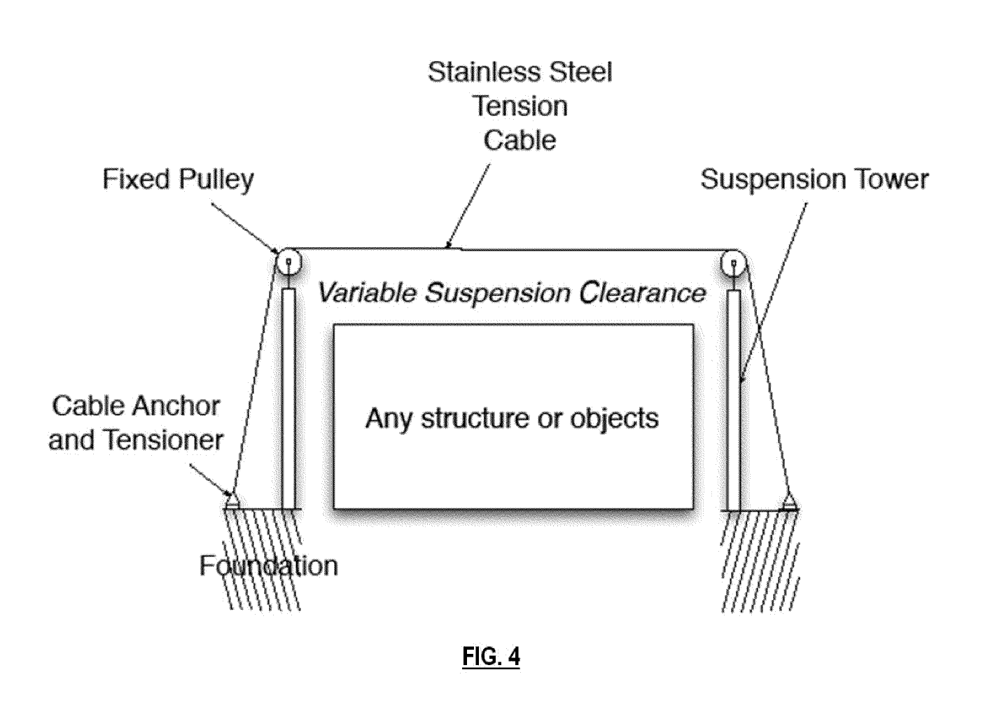

FIG. 5 is the concept drawing showing curved steel mast and dual string support.

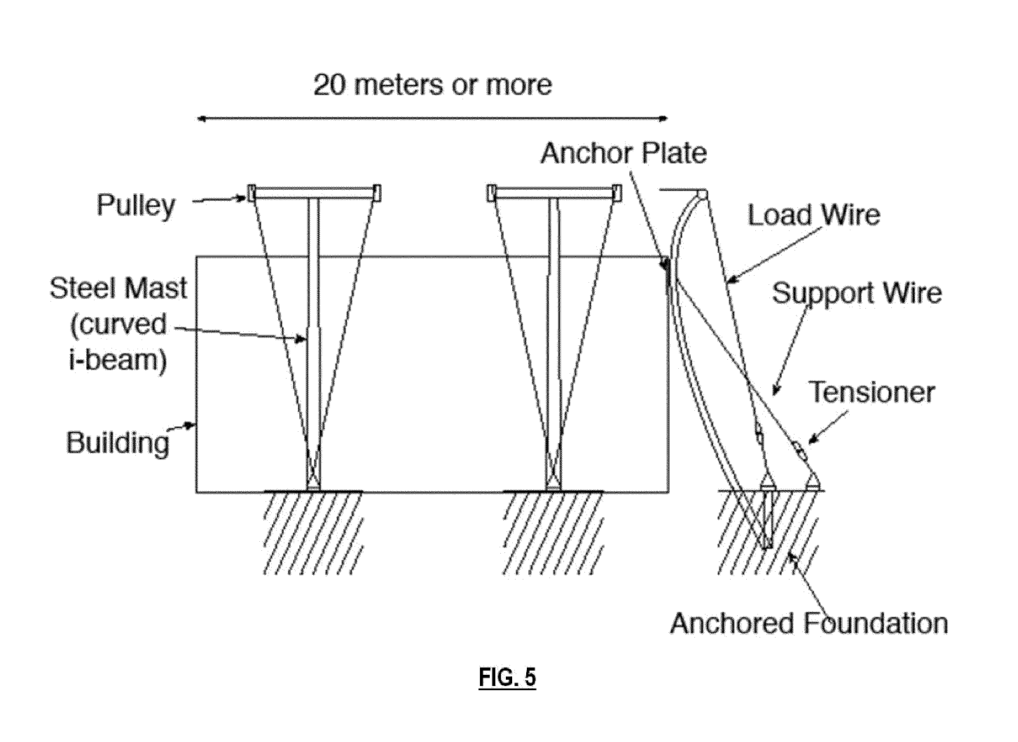

FIG. 6 is the concept drawing showing straight steel mast and dual string support.

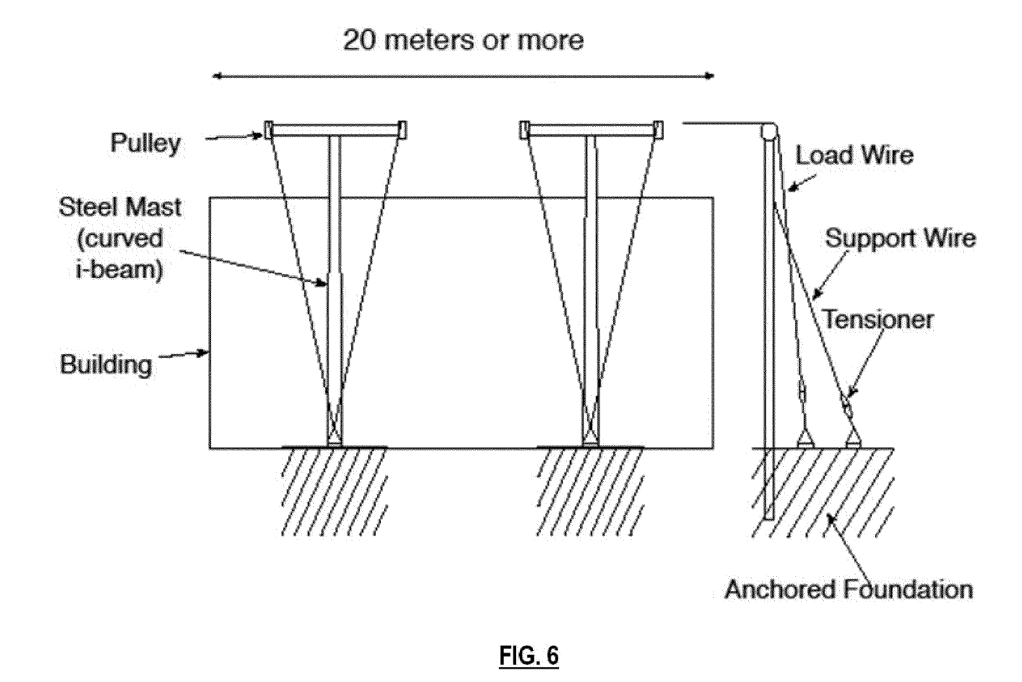

What is claimed is:

1. Solar Panel mounting method utilizing steel cables and not requiring roof penetrations or ballast.

2. A Solar Panel mounting method according to claim 1, wherein, steel cables are anchored through building wall or to ground mounts.

3. A Solar Panel mounting method according to claim 1, which allows provides a secondary roof canopy over the roof consisting of solar panels, and which allows continued access for construction and maintenance of the water barrier roof surface.

4. A Solar Panel mounting method according to claim 1, where panels can be oriented along any required solar azimuth.

5. A Solar Panel mounting method that maximizes the ratio between insolation surface area and ground-connected structures.

6. A solar panel mounting method according to claim 5 that can be deployed over any large surface area without impinging on its access or use.
